(19) United States
(12) Patent Application Publication
(10) Pub. No.: US 2017/0210307 A1
(43) Pub. Date: Jul. 27, 2017

(54) ATTACHMENT FOR ELECTRICAL COMPONENTS

(71) Applicant: Toyota Motor Engineering & Manufacturing North America, Inc., Erlanger, KY (US)

(72) Inventors: Gerritt Benjamin Meyers, Ypsilanti, MI (US); John A. Scheick, Ann Arbor, MI (US)

(21) Appl. No.: 15/004,172

(22) Filed: Jan. 22, 2016

(51) Int. Cl. B60R 16/023; B60R 21/01

(52) U.S. Cl. CPC B60R 16/0239; B60R 21/01

(57) ABSTRACT

Electrical component systems to retain one or more electrical components during external forces are provided in a vehicle. The systems can include an electrical component, such as a vehicle ECU. An attachment bracket can be operatively connect the electrical component to vehicle structure, such as a vehicle floor panel. The attachment bracket can include a front attachment portion configured for operative connection to the vehicle structure. A central attachment is provided to operatively connect the electrical component to a main body of the attachment bracket. The central attachment can include an adhesive such as a two-sided tape. In some arrangements, the system can be configured to retain a vehicle airbag ECU to a vehicle floor panel during impacts to the vehicle.

### FIELD

The subject matter described herein relates in general to electrical components, and more particularly, to the attachment of electrical components to vehicle structure.

### BACKGROUND

Modern vehicles include numerous electrical components to perform various functions. Examples of such electrical components can include electronic circuit boards, electronic control units (ECUs) (e.g., airbag ECUs), event data recorders (EDRs), and computing systems (e.g., entertainment systems, navigation systems). Such electrical components can be attached to a vehicle structure in positions and/or orientations. For example, ECUs can be attached to a vehicle floor panel. During certain situations (e.g., vehicle impacts), the vehicle structure to which an electrical component is attached can deform.

### SUMMARY

In one respect, the subject matter described herein is directed to an electrical component system for a vehicle. The system can include a vehicle structure defining an attachment surface. The system can further include an electrical component having a body. The system can include an attachment bracket, where the electrical component can be operatively connected to the attachment surface at least in part by the attachment bracket. The attachment bracket can include a main body having a front side and a rear side. The attachment bracket can further include a front attachment portion connected to the main body at the front side, and the front attachment portion can be operatively connected to the vehicle structure. The system can further include a central attachment configured to operatively connect the electrical component to the main body of the attachment bracket.

In another respect, the subject matter described herein is directed to an airbag ECU system for a vehicle. The system can include a vehicle floor panel defining an attachment surface and an airbag ECU. The system can further include an attachment bracket, where the airbag ECU can be operatively connected to the attachment surface at least in part by the attachment bracket. The attachment bracket can include a main body and a front attachment portion connected to the main body. The front attachment portion can be operatively connected to the vehicle floor panel at a first location. The system can include an adhesive layer including two-sided tape, the adhesive layer being configured to operatively connect the ECU body to the main body of the attachment bracket. The adhesive layer can be configured to prevent relative movement between the ECU body and the main body of the attachment bracket.

### BRIEF DESCRIPTION OF THE DRAWINGS

FIG. 1 is an example of a portion of a vehicle showing an electrical component operatively connected to a vehicle structure by an attachment bracket.

FIG. 2 is a close-up view showing the example electrical component and attachment bracket of FIG. 1.

FIG. 3 is a partial cross-sectional view of the vehicle, viewed along line 3-3 and showing an initial condition.

FIG. 4 is a partial cross-sectional view of the vehicle, showing a deformed condition.

### DETAILED DESCRIPTION

This detailed description relates to the attachment of electrical components within a vehicle. This detailed description is more particularly related to an attachment bracket, a central attachment, and an electrical component. The central attachment can include an adhesive, such as a two-sided tape, positioned between the attachment bracket and the electrical component. The present detailed description relates to apparatus and/or systems that incorporate one or more of such features. In at least some instances, arrangements described herein can reduce or eliminate conditions in which the electrical component completely detaches from an attachment surface of the vehicle. Further, arrangements can control and/or influence the relative movement and/or rotation of the electrical component when a force is applied.

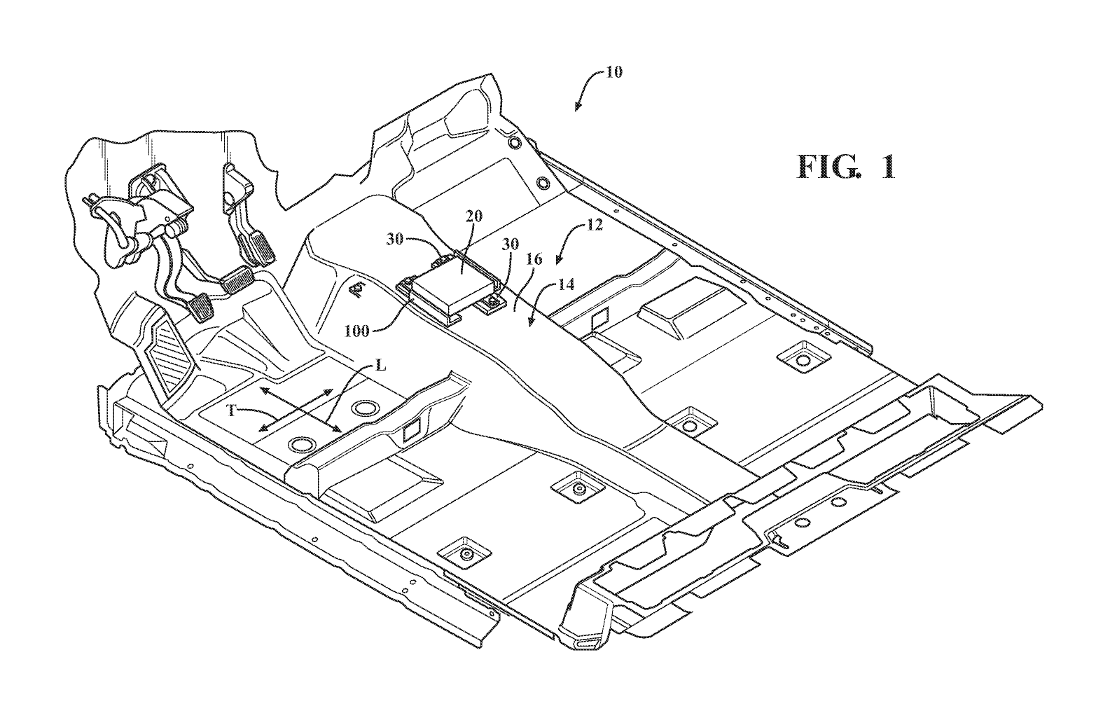

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an example of a portion of a vehicle 10 is shown. As used herein, “vehicle” means any form of motorized transport. In one or more implementations, the vehicle 10 can be an automobile. While arrangements will be described herein with respect to automobiles, it will be understood that embodiments are not limited to automobiles. In some implementations, the vehicle 10 may be a watercraft, an aircraft, a train, a space craft, or any other form of transport.

The vehicle 10 can define an interior that can be configured to receive one or more vehicle occupants. For example, the interior can be partially defined by a floor panel 12. The floor panel 12 can be configured to extend along a bottom portion of the vehicle 10. The floor panel 12 may be covered by carpeting or other material to improve the aesthetic appearance of the vehicle 10 and/or for other purposes. Further, vehicle components, including, for example, seating, storage compartments, and/or electrical components can be operatively connected to the floor panel 12. The term “operatively connected” as used throughout this description, can include direct or indirect connections, including connections without direct physical contact.

One or more electrical components can be operatively connected to one or more surfaces within the vehicle 10. As used herein, “electrical components” can include components configured to control and/or perform one or more aspects and/or functions of an electrical system of the vehicle 10. FIG. 1 shows one example of an electrical component 20 within the vehicle 10. In one or more arrangements, the electrical component 20 can be a vehicle electronic control unit (ECU) and/or an event data recorder (EDR). For example, the electrical component 20 can be an airbag ECU and/or an airbag EDR. In such arrangements, the electrical component 20 can include an ECU configured to detect and/or evaluate conditions of the vehicle 10 in which one or more airbags should be deployed. In one or more arrangements, the electrical component 20 can be operatively connected to one or more sensors (not shown) to detect information about a condition or property of the vehicle 10, such as speed, acceleration, and/or impact. In one or more arrangements, the electrical component 20 can include an EDR to record data during certain vehicle situations. For example, the EDR can be configured to record information relating to vehicle systems. The EDR can also be configured to record position data of the electrical component 20. For example, the EDR can be configured to record information relating to a location and/or an orientation of the electrical component 20.

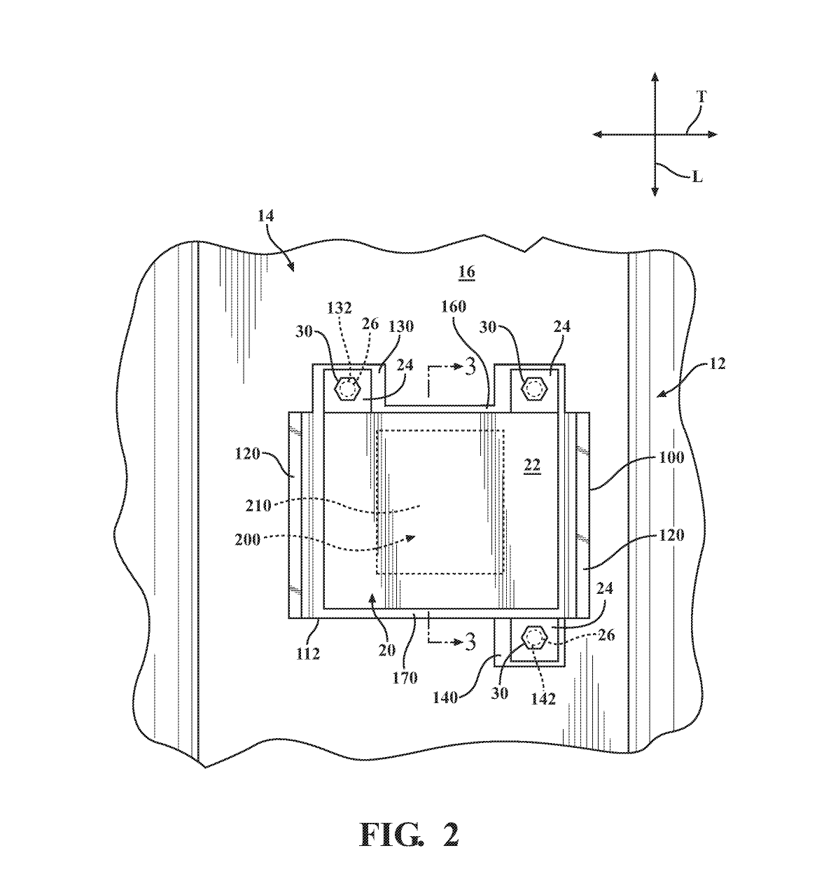

In one or more arrangements, the electrical component 20 can be operatively connected to one or more vehicle structures, such as the floor panel 12. For instance, the electrical component 20 can be operatively connected to the floor panel 12 at or near a tunnel 14. In one or more arrangements, the tunnel 14 can include an attachment surface 16. In some instances, at least a portion of the attachment surface 16 can be substantially planar. As used herein, the term “substantially” includes exactly the term it modifies and slight variations therefrom. Thus, the term “substantially planar” means exactly planar and slight variations therefrom (e.g., within normal manufacturing tolerances, within about 10% or less, within about 5% or less, etc.). In one or more arrangements, the attachment surface 16 can extend in a longitudinal direction L and a transverse direction T, as shown in FIGS. 1 and 2. In some arrangements, the longitudinal direction L can be substantially parallel to a longitudinal axis of the vehicle (e.g., a fore-aft direction) and the transverse direction T can be substantially parallel to a transverse axis of the vehicle (e.g., a side-to-side direction).

The electrical component 20 can have a body 22. The body 22 can have any suitable size, shape, and/or configuration. The body 22 can form a housing for portions of one or more electrical subcomponents, such as electrical conductors, wiring, circuit boards, processors, and/or memory for one or more ECUs/and/or EDRs, for example. The body 22 can be any suitable material, including plastics and/or metals.

The electrical component 20 can have one or more attachment features configured to operatively connect the electrical component 20 to the vehicle 10. For example, the electrical component 20 can include one or more attachment tabs 24. The attachment tabs 24 can extend outward from the body 22 as shown in FIG. 2. In one or more arrangements, the attachment tabs 24 can be substantially planar and can extend substantially parallel to each another. In one or more arrangements, one or more of the attachment tabs 24 can include an aperture 26 defined therein. The aperture 26 can be configured to receive a fastener. The fastener can operatively connect the electrical component 20 to the attachment surface 16. For example, the apertures 26 can be configured to receive a bolt 30. The attachment tabs 24 can be formed together with the body 22 as a unitary structure. Alternatively, the attachment tabs 24 can be formed separate from the body 22 and subsequently operatively connected to the body 22. The attachment tabs 24 can be any suitable material, including plastics and/or metals. For example, the attachment tabs 24 can be made of an aluminum alloy.

In one or more arrangements, the electrical component 20 can be operatively connected to the floor panel 12 by an attachment bracket 100. For instance, the attachment bracket 100 can be configured to be positioned between at least a portion of the electrical component 20 and the attachment surface 16, as shown in the Figures.

In one or more arrangements, the attachment bracket 100 can include a main body 110. The main body 110 can have any suitable size, shape, and/or configuration. In some instances, at least a portion of the main body 110 can be shaped to substantially match the contour of one or more portions of the attachment surface 16. For example, the main body 110 can include a substantially planar surface.

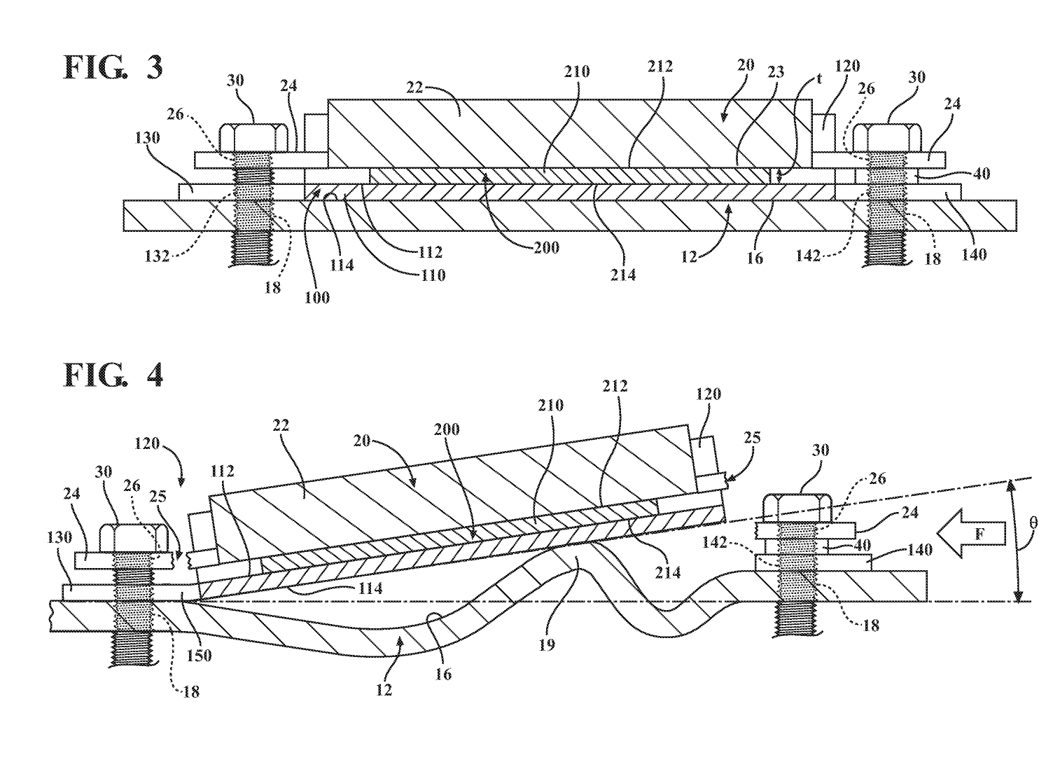

In one or more arrangements, the main body 110 can include an outer surface 112 and an inner surface 114 (see FIG. 3). The outer surface 112 can face away from the attachment surface 16. The inner surface 114 can face toward the attachment surface 16. In one or more arrangements, the outer surface 112 can be configured to contact at least a portion of the electrical component 20 and/or an attachment. For example, as discussed below, the outer surface 112 of the main body 110 can be in direct contact with a central attachment 200.

In one or more arrangements, the attachment bracket 100 can include one or more side walls 120. The one or more side walls 120 can extend away from the main body 110. The one or more side walls 120 can extend in any suitable direction away from the main body 110. For example, as shown in FIGS. 2-4, the attachment bracket 100 can have two side walls 120 on opposing end portions of the main body 110. The side wall(s) 120 can extend at an angle relative to the main body 110. For example, the side wall(s) 120 can extend substantially perpendicular to the main body 110. In some non-limiting examples in which there are two side walls 120, the side walls 120 can be substantially parallel to each other. In one or more arrangements, the side wall(s) 120 can be substantially parallel with the longitudinal axis L.

In one or more arrangements, the main body 110 of the attachment bracket 100 can include one or more attachment portions. For instance, the attachment bracket can include one or more front attachment portions 130 and one or more rear spacer portions 140. In some arrangements, the quantity of front attachment portions 130 can be different from the quantity of rear spacer portions 140. For example, in one or more arrangements, the attachment bracket 100 can include two front attachment portions 130 and one rear spacer portion 140. In some arrangements, the quantity of front attachment portions 130 can be the same as the quantity of rear spacer portions 140.

In some arrangements, the front attachment portion(s) 130 can be connected to the main body 110 at an end portion of the attachment bracket 100. For example, the front attachment portion(s) 130 can extend from a front side 160 of the attachment bracket. The rear spacer portion 140 can be located near a rear side 170 of the attachment bracket. The terms “front” and “rear” are used in this respect to indicate the general location of the attachment portion relative to the front end and rear of the vehicle 10. The terms are used merely for convenience to facilitate the description. Therefore, it will be understood that they are not intended to be limiting.

The front attachment portion(s) 130 can be configured to facilitate the operative connection of the attachment bracket 100 to the electrical component 20 and/or the attachment surface 16. For example, the front attachment portion(s) 130 can include one or more apertures 132 (FIG. 3). The rear spacer portion(s) 140 can include one or more apertures 142 (FIG. 3). The front attachment portion(s) 130 and/or the rear spacer portion(s) 140 can be configured for operative connection to one or more attachment tabs 24 of the electrical component 20. For example, the apertures 132 and/or 142 defined in the front attachment portion(s) 130 or rear spacer portion(s) 140 can be substantially aligned with the aperture(s) 26 defined in the attachment tabs 24. Further, the front attachment portion(s) 130 and/or the rear spacer portion(s) 140 can be configured for operative connection to the attachment surface 16 of the floor panel 12. For example, the aperture(s) 132 and/or 142 can be substantially aligned with apertures 18 defined in the floor panel 12. In one or more arrangements, a bolt 30 can extend through the aperture 132 or 142 and the aperture 26. In addition, the bolt 30 can extend at least partially through the aperture 18 in the floor panel 12. The bolt 30 can retain the various structures together in any suitable manner. For instance, the bolt 30 can be configured to threadingly engage the front attachment portion 130 or the rear spacer portion 140, the attachment tab 24, and/or the floor panel 12. Alternatively or in addition, the bolt 30 can threadingly engage a threaded nut (not shown) or other retainer element to provide operative connection of the components.

In one or more arrangements, the attachment bracket 100 can include one or more front attachment portions 130 without any rear spacer portions 140. For instance, the attachment bracket 100 can be operatively connected to the floor panel 12 only at locations near the front side 160. In some arrangements, the attachment bracket 100 can include two front attachment portions 130 bolted or otherwise attached to the floor panel 12, without any rear spacer portion 140.

The attachment bracket 100 can be made of a variety of suitable materials. For example, the attachment bracket 100 can be made of any suitable metal, such as steel. In one or more arrangements, a thickness of the attachment bracket 100 can be substantially constant. In one or more arrangements, the thickness of the attachment bracket 100 can vary in one or more locations, or the thickness of the attachment bracket 100 can continuously vary across the entire attachment bracket 100 in one or more directions.

The attachment bracket 100 can be made using any suitable process, including, for example, stamping, bending, and/or cutting. In one or more arrangements, the attachment bracket 100 can be formed as a single piece. In one or more arrangements, the attachment bracket 100 can be made of a plurality of separate pieces. The plurality of separate pieces can be joined together in any suitable manner, including, for example, welding, brazing, adhesives, and/or one or more fasteners.

In one or more arrangements, the electrical component 20 can be operatively connected to the attachment bracket 100 via the central attachment 200. The central attachment 200 can include any element configured to operatively connect the electrical component 20 to the main body 110 of the attachment bracket 100. In one or more arrangements, the central attachment 200 can be any suitable chemical and/or mechanical fastener.

In one or more arrangements, the central attachment 200 can include one or more adhesives 210. The adhesive 210 can be configured to be positioned between the electrical component 20 and the attachment bracket 100. For example, the adhesive 210 can be in direct contact with an inner surface 23 of the body 22 of the electrical component 20. Further, the adhesive 210 can be in direct contact with an outer surface 112 of the main body 110 of the attachment bracket 100. The adhesive 210 can include any natural and/or synthetic glue, cement, mucilage, tape, and/or paste. In one or more arrangements, the adhesive 210 can be a pressure-sensitive tape (PSA tape) configured to bind with a surface through application pressure without the need for a solvent.

In one or more arrangements, the adhesive 210 can be in the form of, or carried by, a two-sided tape. For instance, the adhesive 210 can be a PSA tape having adhesive on opposite sides. In one or more arrangements, the adhesive 210 can a two-sided acrylic foam tape. For example, the two-sided tape can be a two-sided tape in the RT8000 series, manufactured by 3M, Maplewood, Minn. In one or more arrangements, the adhesive and/or adhesive properties on one side of the tape can be substantially identical to the adhesive and/or adhesive properties on the other side of the tape. In one or more arrangements, the adhesive and/or adhesive properties on one side of the tape can be different from the adhesive and/or adhesive properties on the other side of the tape.

The adhesive 210 can include an outer surface 212 and an inner surface 214. In one or more arrangements, the outer surface 212 can be configured to contact a portion of the inner surface 23 of the body 22 of the electrical component 20. In one or more arrangements, the inner surface 214 can be configured to contact a portion of the outer surface 112 of the main body 110 of the attachment bracket 100.

The outer surface 212 and/or the inner surface 214 can have any suitable size, shape, and/or configuration. For instance, the outer surface 212 and/or the inner surface 214 can form a substantially rectangular shape (as shown in FIG. 2). Alternatively, the outer surface 212 and/or the inner surface 214 can form other shapes, such as a substantially circular, substantially oval, substantially triangular, or substantially polygonal shape, just to name a few possibilities. The size of the outer surface 212 and/or the inner surface 214 can be varied based on application. In one or more arrangements, the outer surface 212 and the inner surface 214 can be substantially the same size, shape, and/or configuration. Alternatively, the outer surface 212 and the inner surface 214 can have different sizes, shapes, and/or configurations. For instance, the outer surface 212 and the inner surface 24 can have different size with one larger than the other.

In one or more arrangements, the adhesive 210 can be continuous. For example, the adhesive 210 can include one continuous piece of a two-sided tape. Alternatively, the adhesive 210 can include two or more separate pieces of two-sided tape. For example, the adhesive 210 can include two or more distinct pieces of a two-sided tape positioned at different locations.

The adhesive 210 can have any suitable thickness t (FIG. 3). The thickness t can be the distance between the outer surface 212 and the inner surface 214 of the adhesive 210. In one or more arrangements, the adhesive 210 can have a thickness t from about one millimeter (mm) and about four millimeters. In one or more arrangements, the thickness of the adhesive 210 can be substantially constant. The thickness t of the adhesive 210 can vary in one or more locations. In one or more arrangements, the thickness t can continuously vary in one or more directions within the adhesive 210.

The electrical component 20, the attachment bracket 100, and/or the vehicle structure can be subject to certain loading conditions. One or more of such components can deform under the loading conditions. As used herein, “deform” can include any situations in which structure rotates, twists, bends, curves, folds, crumples, breaks, cracks, and/or otherwise changes shape relative to an initial condition. The “initial condition” means the shape, size, and/or configuration of structure prior to any deformation. A “deformed condition” can include any shape, size, and/or configuration of the electrical component 20, attachment bracket 100, and/or the vehicle structure subsequent to deformation caused by one or more forces.

FIG. 3 shows an example of an initial condition of the electrical component 20, the attachment bracket 100, and the floor panel 12. In some arrangements, FIG. 3 can show the components before a force is applied. The attachment surface 16 can have a substantially planar shape during the initial condition. In one or more arrangements, the front attachment portion 130 and the rear spacer portion 140 can be operatively connected to the floor panel 12 via bolts 30. In some arrangements, one or more spacers 40 can be used. For example, a middle spacer 40 can be positioned between an attachment tab 24 of the electrical component 20 and the rear spacer portion 140 of the attachment bracket 100. In some arrangements, the middle spacer 40 can have a height approximately the same as the thickness t of the adhesive 210. Alternatively or in addition, in some instances, one or more middle spacers 40 can be positioned between an attachment tab 24 of the electrical component 20 and the front attachment portion 130 of the attachment bracket 100.

The attachment bracket 100 and the central attachment 200 can be configured to retain the electrical component 20 in certain positions during an application of a force F (FIG. 4). The force F can be applied as a result of one or more conditions. For instance, in one or more arrangements, the force F can be generated during a vehicle collision. The force F can be any type of force. For instance, the force F can be a compressive force acting on the vehicle floor panel 12. In some arrangements, the force F can result from a frontal impact of the vehicle 10 or from a rear impact of the vehicle 10. The force F can be applied to the floor panel 12.

FIG. 4 shows a deformed condition as a result of the application of the force F. In one or more arrangements, the force F can cause the floor panel 12 to deform. In some arrangements, the floor panel 12 can be compressed by the force F and one or more bends can be formed in the floor panel 12. For instance, the bends can include an upward bend 19. The upward bend 19 can include a portion of the floor panel that is moved upward from the initial position. In one or more arrangements, the upward bend 19 can contact the main body 110 of the attachment bracket 100 and apply a force to the attachment bracket 100. In such case, the force can include a component in the upward direction toward the attachment bracket 100.

During deformation of the floor panel 12, the main body 110 of the attachment bracket 100 can move relative to an initial position prior to the force F being applied. For example, the deformation of the floor panel 12 can cause portions of the main body 110 to move in an upward direction. In some arrangements, the main body 110 can rotate relative to the front attachment portion(s) 130 via one or more bends 150. The main body 110 can be separated from the rear spacer portion 140 during the application of the force F.

In one or more arrangements, the main body 110 of the attachment bracket 100 and the body 22 of the electrical component 20 can be rotated from the initial condition. For example, the main body 110 can be rotated an angle θ from the initial condition to the deformed condition. In one or more arrangements, a maximum relative movement of the electrical component 20 can be established based on a characteristic of the electrical component 20. For example, an airbag ECU and/or an airbag EDR can be configured to provide reliable data at certain angular positions relative to horizontal and/or up to a certain amount of rotational movement. In some arrangements, the angle θ can be a maximum of about 20 degrees or less.

In some instances, the attachment tabs 24 of the electrical component 20 can be configured to crack, break, or otherwise fail at a predetermine location, such as at a break point 25. For example, the attachment tab 24 can be a brittle material such as an aluminum alloy. In one or more arrangements, the electrical component 20 can be retained by the central attachment 200 to the main body 110 of the attachment bracket 100. The central attachment 200 can prevent movement of the body 22 of the electrical component relative to the main body 110 of the attachment bracket 100. For example, even if the attachment tabs 24 break off from the body 22 of the electrical component 20, the body 22 of the electrical component 20 can remain attached to the main body 110 of the attachment bracket 100.

Now that the various potential systems, devices, elements and/or components of the vehicle 10, the electrical component 20, the attachment bracket 100, and the central attachment 200 have been described, one manner of connecting the elements will now be described. Various possible steps will now be described. The described steps may be applicable to the arrangements described above in relation to FIGS. 1-4, but it is understood that the steps can be carried out with other suitable systems and arrangements. Moreover, steps other than those described here can be included, and in fact, arrangements are not limited to including every step described. Further, while a particular chronological order may be described, arrangements described herein are not limited to any particular chronological order.

The electrical component 20, the central attachment 200, the attachment bracket 100, and the floor panel 12 can be brought together so that at least a portion of the electrical component 20 contacts the outer surface 212 of the central attachment 200. Further, at least a portion of the attachment bracket 100 can contact the inner surface 214 of the central attachment 200. A portion of the attachment bracket 100 can contact the attachment surface 16 of the floor panel 12. In one or more arrangements, an aperture 26 in an attachment tab 24 can be substantially aligned with an apertures 132 in a front attachment portion 130. Further, an aperture 26 in an attachment tab 24 can be substantially aligned with an aperture 142 of a rear attachment 140.

The electrical component 20 and the attachment bracket 100 can be operatively connected to the floor panel 12 of the vehicle using bolts 30 and/or other suitable fasteners. The bolt 30 and/or other fastener can be retainably engaged by threaded engagement with the floor panel 12 or by a retainer element (e.g., a nut).

It will be appreciated that arrangements described herein can provide numerous benefits, including one or more of the benefits mentioned herein. One or more arrangements described herein can provide attachment structure for electrical components that can move and/or deform as forces are applied to a mounting surface. For instance, arrangements described herein can include an airbag ECU and/or an airbag EDR operatively connected to a vehicle floor panel. During certain vehicle impacts, the vehicle floor panel can deform, collapse, and/or otherwise transfer forces to the ECU/EDR. Arrangements described herein can receive such forces while still providing retention of the ECU/EDR body. The central attachment can retain the ECU/EDR to the attachment bracket even if one or more attachment tabs break. The arrangements described herein can limit the relative movement and rotation of the electrical component during the application of a force. Arrangements described herein can control and/or influence deformation to maintain the electrical component in a position and/or orientation that allow the electrical component to continue to function properly and/or to maintain accuracy of the electrical component within predetermined specifications.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. An electrical component system for a vehicle, the system comprising:
a vehicle structure defining an attachment surface;
an electrical component having a body;
an attachment bracket, the electrical component being operatively connected to the attachment surface at least in part by the attachment bracket, the attachment bracket including:
a main body having a front side and a rear side;
a front attachment portion connected to the main body at the front side, the front attachment portion being operatively connected to the vehicle structure; and
a central attachment configured to operatively connect the electrical component to the main body of the attachment bracket.

2. The system of claim 1, wherein, upon application of one or more forces, the vehicle structure deforms from an initial condition to a deformed condition, wherein the deformed condition includes a portion of the vehicle structure moving upwardly into contact with the attachment bracket, and wherein as the vehicle structure deforms from the initial condition to the deformed condition:
the main body is configured to rotate relative to the front attachment portion as the vehicle structure deforms from the initial condition to the deformed condition, and
the central attachment is configured to prevent relative movement between the body of the electrical component and the main body of the attachment bracket.

3. The system of claim 2, wherein the attachment bracket is configured such that, as the vehicle structure deforms from the initial condition to the deformed condition, the main body rotates a maximum angle of about 20 degrees or less relative to the initial condition.

4. The system of claim 1, wherein the central attachment includes an adhesive.

5. The system of claim 1, wherein the central attachment is a two-sided tape.

6. The system of claim 5, wherein the two-sided tape has an associated thickness, the thickness of the two-sided tape being substantially constant, and wherein the thickness is from about one millimeter to about four millimeters.

7. The system of claim 1, wherein the electrical component includes at least one attachment tab.

8. The system of claim 7, further including a fastener, wherein:
the at least one attachment tab of the electrical component includes at least one aperture;
the front attachment portion of the attachment bracket includes at least one aperture;
the vehicle structure includes at least one aperture; and
the at least one aperture in each of the at least one attachment tab, the front attachment portion, and the vehicle structure are substantially aligned to receive the fastener, whereby the electrical component, the attachment bracket and the vehicle structure are operatively connected together.

9. The system of claim 1, further including a rear spacer portion, wherein the rear spacer portion is operatively connected to the vehicle structure.

10. The system of claim 9, wherein the rear spacer portion is a separate structure from that of the main body.

11. The system of claim 1, wherein the central attachment directly contacts the main body and the central attachment.

12. An airbag ECU system for a vehicle, the system comprising:
a vehicle floor panel defining an attachment surface;
an airbag ECU;
an attachment bracket, the airbag ECU being operatively connected to the attachment surface at least in part by the attachment bracket, the attachment bracket including:
a main body; and
a front attachment portion connected to the main body, the front attachment portion being operatively connected to the vehicle floor panel at a first location; and
an adhesive layer including two-sided tape, the adhesive layer configured to operatively connect the ECU body to the main body of the attachment bracket,
the adhesive layer configured to prevent relative movement between the ECU body and the main body of the attachment bracket.

13. The system of claim 12, wherein:
the vehicle floor panel is configured to deform from an initial condition to a deformed condition upon an application of a force, at least a component of the force causing the vehicle floor panel to bend near the attachment bracket, and
the main body is configured to rotate relative to the front attachment portion as the vehicle floor panel deforms from the initial condition to the deformed condition.

14. The system of claim 12, wherein the adhesive layer includes two-sided tape having a thickness between about one millimeter and four millimeters.

15. The system of claim 12, wherein:
the ECU body has a plurality of attachment tabs, each of the plurality of attachment tabs having at least one aperture;
the front attachment portion of the attachment bracket includes at least one aperture;
the vehicle floor panel includes at least one aperture; and
the at least one aperture in each of the at least one attachment tab, the front attachment portion, and the vehicle floor panel are substantially aligned and operatively connected via a fastener.

16. The system of claim 12, further including a rear spacer portion operatively connected to the vehicle floor panel.

17. The system of claim 16, wherein the rear spacer portion is a separate structure from that of the main body.

18. The system of claim 12, wherein, during deformation, the main body rotates less than a maximum angle of about 20 degrees relative to the initial condition.
